(19) United States
(12) Patent Application Publication
(10) Pub. No.: US 2006/0092622 A1
(43) Pub. Date: May 4, 2006

(54) Portable light-emitting device with a built-in retractable member

(76) Inventor: Sai Ying Tam, Kowloon (HK)

Correspondence Address: RABIN & Berdo, PC, 1101 14TH STREET, NW, SUITE 500, WASHINGTON, DC, 20005, US

(21) Appl. No.: 11/265,153

(22) Filed: Nov. 3, 2005

(30) Foreign Application Priority Data
Nov. 4, 2004 (CN) 200420112073.1

(51) Int. Cl. F21V 33/00

(52) U.S. Cl. 362/99; 362/259; 362/208; 362/202

(57) ABSTRACT

The present invention relates to a portable light-emitting device with a built-in retractable member, which comprises: a housing partitioned into a first section and a second section; a light-emitting composed of a lighting head and a power source that are disposed in the first section; and a retractable member composed of a roller and a tape that are disposed in the second section in such a manner that the tape can be retracted through a slot provided on the housing. The technical effect of the present invention is that it provides a light source for everybody being on a darker side as well as the functions of taking notes, recording various relevant information, placing advertisement and dissemination of information are integrated thereinto. The present invention is small in size, portable and convenient to use.

### TECHNICAL FIELD

The present invention relates to an illuminator, and more particularly to a portable light-emitting device with a built-in retractable member.

### BACKGROUND OF THE INVENTION

Without a fixed power supply or light source, people could desire a light source and wish to retrieve information or to take a note as well. For example, a map or an emergency telephone number together with a light source could be able to help one to escape with bare life after an earthquake or a power breakdown or the like occurred. Moreover, for an operation at night or under the condition of inadequate illumination, there could be much helpful if some general information in connection with the operation is recorded in advance or brief notes can be taken in the course of the operation. For example, the information may contain first-aid information including names, addresses, or telephone numbers in need. For advertising purpose, the information may contain promotional message and product information and the like. Therefore, what is needed is a device that combines the illuminating and information incorporating features together, whereby providing such a device that is simple in construction and easy to use.

Presently, a commonly used portable light-emitting device is an electric torch, which is mainly used for illumination or warning. With the progress and development of science and technology, a computer together with a digital projector or a big screen are frequently used in the course of educational or business communication, wherein a laser pointer becomes more and more commonly used by the speaker. However, as yet, no such a light-emitting device exists, which possesses illuminating or pointing features as well as the abilities of taking notes, recording various relevant information and so on.

### SUMMARY OF THE INVENTION

The present invention is configured in consideration of the technical problems to be solved. An object of the present invention is to provide a portable light-emitting device with a built-in retractable member, wherein relevant information can be printed, stored or recorded on the retractable member, whereby both integrating the illuminating or pointing features and providing an added notes taking feature.

In order to achieve above mentioned object, the present invention provides a portable light-emitting device with a built-in retractable member, characterized in that the device comprises a housing partitioned into a first section and a second section; a light-emitting device composed of a lighting head and a power source, which are disposed in the first section; and a retractable member composed of a roller and a tape, which are disposed in the second section in such a manner that the tape can be retracted through a slot provided on the housing.

In the portable light-emitting device with a built-in retractable member in accordance with the present invention, a clip member is provided on one side of said housing; said housing is pen-like, which is made of transparent material; said lighting head is a bulb, or a LED, or a laser diode; said tape is made of paper, cloth, film, plastic and composite materials thereof; and a stopper is provided at one end of said tape which is adapted to cooperate with the slot on the housing. As the power source, either button cells or regular batteries may be used.

Alternatively, the housing of said portable light-emitting device may be manufactured in solid colors.

The technical effect of the present invention is that it provides a light source for everybody being on a darker side as well as the functions of taking notes, recording various relevant information, placing advertisement and dissemination of information are integrated thereinto. For example, an emergency or security telephone number, a map or other information can be written on the tape, which are available for use when an accident (e.g. earthquake or a power breakdown) occurred. Alternatively, a commercial advertisement or a calendar can be printed thereon for the clients, or the tape can be simply used as a normal memorandum. The portable light-emitting device with a built-in retractable member of the present invention is small in size, portable and convenient to use.

The present invention will be described in more detail based on the following description of an embodiment with reference to the accompanying drawings and it is not intended as a definition of the limits of the invention.

### BRIEF DESCRIPTION OF THE DRAWINGS

FIG. 1 is a perspective view of an embodiment of the present invention.

FIG. 2 is a cross-sectional view of the embodiment of the present invention.

FIG. 3 is a perspective view of the embodiment of the present invention illustrating the tape in a pulled out form.

### DETAILED DESCRIPTION OF THE PREFERRED EMBODIMENTS

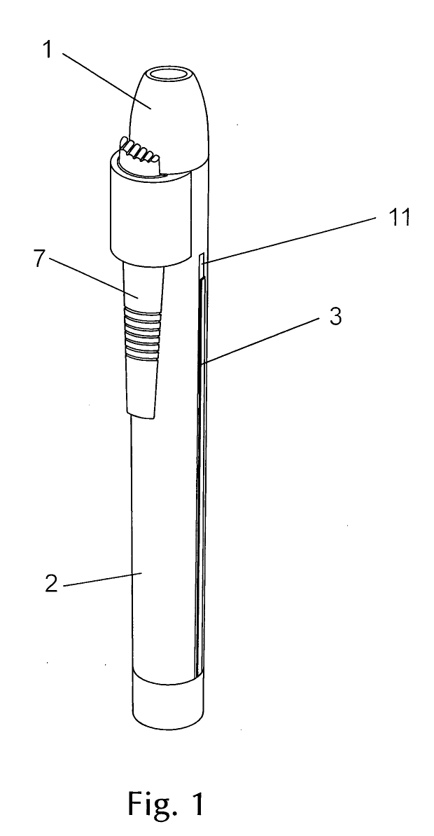

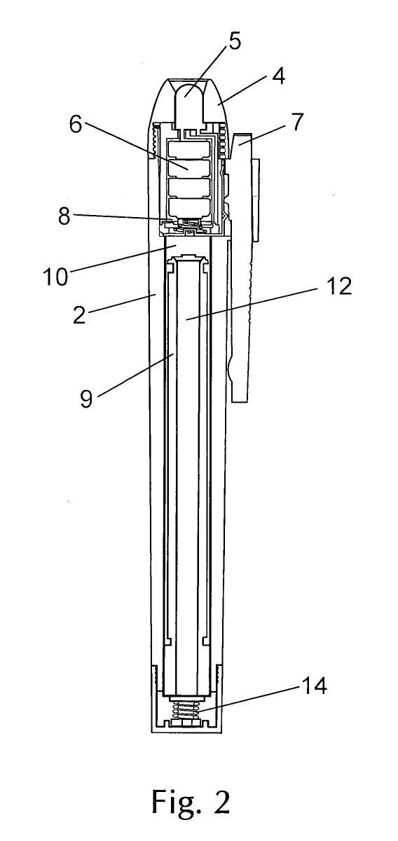

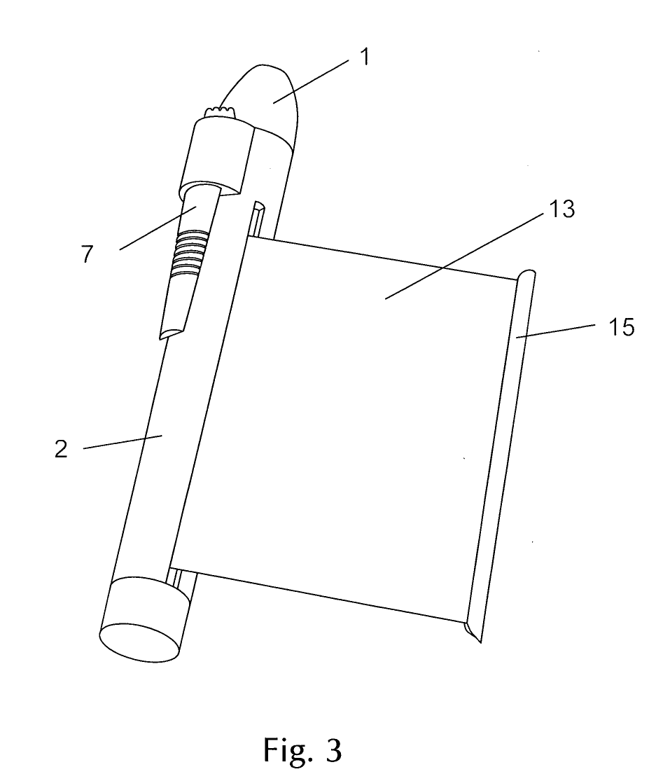

Referring to FIGS. 1 and 2, an embodiment of a portable light-emitting device with a built-in retractable member of the present invention is shown, which comprises:
a housing 2 which is partitioned into a first section 8 and a second section 9 by a separating member 10, the housing 2 is pen-like, and a clip member of which is formed as an on-off element 7 of the light-emitting device 1, and the top surface and the lower surface of which is knurled to provide traction for one's finger while in use; a lighting head 5 and a power source 6 thereof are mounted in the first section 8 and a retractable member 3 is mounted in the second section 9, and an elongated slot 11 extends longitudinally along the housing 2;
a light-emitting device 1, which is disposed in the first section 8 and composed of the lighting head 5 and the power source 6 thereof, wherein the lighting head 5 is a bulb mounted within a truncated cone shaped cover 4 which is connected with the housing 2 in a threaded manner, and the power source 6 can be the button cells or rechargeable cells; and
a retractable member 3, which is composed of a roller 12 and a tape 13 and disposed in the second section 9 in such a manner that the tape can be retracted through the slot 11 provided on the housing 2, wherein one end of the roller 12 is socketed onto the separating member 10, while another end is rotatably supported on the end of the housing through a wind spring 14; one end of the tape 13 is mounted and wound on the roller 12, and a stopper 15 is provided on another end of the tape 13, as shown in FIG. 3; normally, the tape 13 is held in a retracted position under the action of the winding force of the wind spring 14 while the stopper 15 is leaned against the slot 11.

As shown in FIG. 3, the information or recorded items, such as an emergency or security telephone number, a map, text or graphics of an advertisement printed on the tape 13 will becomes visible when the tape 13 is pulled out from the slot 11 of the housing 2, or some notes can be taken on the tape 13. The tape 13 is made of paper, cloth, film, plastic and composite materials thereof, both sides of which can be utilized.

In the portable light-emitting device with a built-in retractable member, a clip member can be provided on one side of the housing for clipping the light-emitting device onto a specific object.

In the portable light-emitting device with a built-in retractable member, the housing is made of transparent material, whereby light will radiate omnidirectionally through the transparent housing when turned on in order to intensify one's vision in the darker place, for example, seeing the menu in the restaurant.

In the portable light-emitting device with a built-in retractable member, the lighting head can also be a LED, or can be replaced by a laser diode in order to use as a laser pointer.

In use, once the on-off element 7 is slightly pressed down and in an active position, a beam of bright light is instantly emitted by the bulb 5 of the portable light-emitting device with a built-in retractable member of the present invention. The bulb 5 is extinguished when the on-off element 7 is slightly pushed up and in an inactive position. The tape 13 is usually wound on the roller 12. If information on the tape 13 needs to be reviewed, as long as the tape 13 is pulled out by means of catching on the stopper 15. This results in that the roller 12 is rotated while the force of the spring 14 holding the roller 12 is to be overcome. The tape 13 is automatically wound back onto the roller 12 under the action of the force of the spring 14 once the tape 13 is released, until the stopper 15 on the tape 13 is rested on the slot 11.

The present invention is designed to be simple in structure, light in weight, and convenient to use, for example, the tape can be automatically wound into the housing after use.

It is understood that many other embodiments of the present invention are also possible, and many corresponding modifications as well as variations can be made by those skills in the art as according to the disclosure of the present invention and without departing from the spirits and essentials thereof, while such modifications and variations fall into the scope of the claims of the present invention.

What is claimed is:

1. A portable light-emitting device with a built-in retractable member, which comprises:
a housing partitioned into a first section and a second section;
a light-emitting device composed of a lighting head and a power source, which are disposed in the first section; and
a retractable member composed of a roller and a tape, which are disposed in the second section in such a manner that the tape can be retracted through a slot provided on the housing.

2. A portable light-emitting device with a built-in retractable member as claimed in claim 1, wherein a clip member is provided on one side of said housing.

3. A portable light-emitting device with a built-in retractable member as claimed in claim 1, wherein said housing is pen-like.

4. A portable light-emitting device with a built-in retractable member as claimed in claim 1, wherein said housing is made of transparent material.

5. A portable light-emitting device with a built-in retractable member as claimed in claim 1, wherein said housing is made of solid color material.

6. A portable light-emitting device with a built-in retractable member as claimed in claim 1, wherein said lighting head is a bulb.

7. A portable light-emitting device with a built-in retractable member as claimed in claim 1, wherein said lighting head is a LED.

8. A portable light-emitting device with a built-in retractable member as claimed in claim 1, wherein said lighting head is a laser diode.

9. A portable light-emitting device with a built-in retractable member as claimed in claim 1, wherein button cells are used as the power source.

10. A portable light-emitting device with a built-in retractable member as claimed in claim 1, wherein regular batteries are used as the power source.

11. A portable light-emitting device with a built-in retractable member as claimed in claim 1, wherein said tape is made of paper, cloth, film, plastic and composite materials thereof.

12. A portable light-emitting device with a built-in retractable member as claimed in claim 1, wherein said tape has a map printed thereon.

13. A portable light-emitting device with a built-in retractable member as claimed in claim 1, wherein said tape contains first-aid information or promotional message and product information and the like.

14. A portable light-emitting device with a built-in retractable member as claimed in claim 1, wherein a stopper is provided at one end of said tape which is adapted to cooperate with the slot on the housing.
